(19) United States
(12) Patent Application Publication
(10) Pub. No.: US 2014/0297297 A1
(43) Pub. Date: Oct. 2, 2014

(54) GENERATING MODELS REPRESENTATIVE OF CLINICAL GUIDELINES AND PROVIDING TREATMENT/DIAGNOSTIC RECOMMENDATIONS BASED ON THE GENERATED MODELS

(71) Applicant: MCKESSON SPECIALTY CARE DISTRIBUTION CORPORATION, (US)

(72) Inventor: Henry Head, Efland, NC (US)

(73) Assignee: MCKESSON SPECIALTY CARE DISTRIBUTION CORPORATION, San Francisco, CA (US)

(21) Appl. No.: 13/853,176

(22) Filed: Mar. 29, 2013

(51) Int. Cl. G06F 19/00

(52) U.S. Cl. CPC G06F 19/345
USPC 705/2

(57) ABSTRACT

Systems, methods, and computer-readable media for generating healthcare models based on clinical treatment or diagnostic guidelines and utilizing such models to identify recommended healthcare treatments and/or recommended diagnostics tests or procedures are disclosed.

### FIELD OF THE DISCLOSURE

This disclosure relates generally to healthcare treatment or diagnostics, and more particularly, to the modeling of clinical treatment or diagnostic guidelines to provide guidance with respect to the selection of healthcare treatments or diagnostic test(s)/procedure(s).

### BACKGROUND

Clinical treatment or diagnostic guidelines may be established for treating or diagnosing a number of medical conditions and may be promulgated by any of a variety of types of entities such as, for example, organizations of medical professionals, expert panels, consortiums of medical research centers, and so forth. For example, in determining an appropriate treatment regimen for a particular medical condition or group of related medical conditions, healthcare providers may utilize associated clinical treatment guidelines to identify treatments that comport with established treatment protocols. A variety of types of information may be analyzed and assessed in generating clinical treatment guidelines such as, for example, information gleaned from clinical studies, statistical evidence associated with various types of treatment, or any other suitable type of evidence. Conventionally, the extent to which healthcare treatments have complied with relevant treatment guidelines has largely depended on how closely healthcare providers have followed such guidelines in selecting and administering such treatments.

### BRIEF DESCRIPTION OF THE DRAWINGS

The detailed description is set forth through reference to the accompanying drawings. In the drawings, the left-most digit(s) of a reference numeral identifies the drawing in which the reference numeral first appears. The use of the same reference numerals indicates similar or identical items; however, similar or identical items may also be designated with different reference numerals. Various embodiments may utilize element(s) and/or component(s) other than those illustrated in the drawings, and some element(s) and/or component(s) may not be present in various embodiments. A description of a component or element using singular terminology may, depending on the context, encompass a plural number of such components or elements and vice versa.

FIG. 1 is a schematic block diagram depicting an illustrative system architecture for determining recommended healthcare treatments based on an analysis of patient healthcare data with respect to a healthcare treatment model associated with relevant clinical treatment guidelines and communicating information identifying the recommended healthcare treatments to a healthcare provider in accordance with one or more embodiments of the disclosure.

FIG. 2 is a schematic block diagram depicting, in accordance with one or more embodiments of the disclosure, various illustrative hardware and software components of illustrative computing device(s) of the system architecture depicted in FIG. 1.

FIG. 3 is a process flow diagram of an illustrative method for determining recommended healthcare treatments based on an analysis of patient healthcare data with respect to a healthcare treatment model associated with relevant clinical treatment guidelines and communicating information identifying the recommended healthcare treatments to a healthcare provider in accordance with one or more embodiments of the disclosure.

FIG. 4 is a process flow diagram of an illustrative method for generating a healthcare treatment model based on clinical treatment guidelines and traversing clinical decision tree(s) of the healthcare treatment model to identify a recommended healthcare treatment in accordance with one or more embodiments of the disclosure.

FIG. 5 is a process flow diagram of an illustrative method for determining recommended diagnostic test(s)/procedure(s) based on an analysis of patient healthcare data with respect to a diagnostics model associated with relevant diagnostic guidelines and communicating information identifying the recommended diagnostic test(s)/procedure(s) to a healthcare provider in accordance with one or more embodiments of the disclosure.

### DETAILED DESCRIPTION OF EMBODIMENTS OF THE DISCLOSURE

### Overview

Embodiments of the disclosure relate to, among other things, systems, methods, computer-readable media, techniques, and methodologies for receiving healthcare data associated with a patient, identifying a healthcare treatment model associated with a set of clinical treatment guidelines, determining a recommended healthcare treatment for the patient based on the received healthcare data and the identified healthcare treatment model, and communicating information identifying the recommended healthcare treatment to a healthcare provider to assist the healthcare provider in selecting an appropriate treatment for the patient that complies with relevant clinical treatment guidelines. Embodiments of the disclosure also relate to, among other things, systems, methods, computer-readable media, techniques, and methodologies for receiving healthcare data associated with a patient, identifying a healthcare diagnostics model associated with a set of diagnostic guidelines, determining recommended diagnostic test(s)/procedure(s) based on the healthcare data and the identified diagnostics model, and communicating information identifying the recommended diagnostic test(s)/procedure(s) to a healthcare provider to assist the healthcare provider in diagnosing one or more medical conditions of the patient. As used herein, the term “healthcare provider” may refer to any medical practitioner authorized to administer or to instruct one or more healthcare treatments to be administered to a patient.

In accordance with one or more embodiments of the disclosure, a healthcare treatment determination system comprising one or more healthcare treatment determination computers may be provided. The healthcare treatment determination system may be configured to communicate—via one or more networks—with one or more healthcare provider systems comprising one or more healthcare provider computers. In certain embodiments, the healthcare treatment determination system and various healthcare provider systems may be configured to exchange information in accordance with a client-server system architecture such as, for example, a Representational State Transfer (REST) web services architecture.

While various embodiments of the disclosure may be described in the context of the determination and selection of treatment regimens for one or more diagnosed medical conditions of a patient, it should be appreciated that embodiments of the disclosure are also applicable to the determination and selection of diagnostic test(s)/procedure(s) for diagnosing one or more medical conditions for a patient. More specifically, in addition to supporting functionality for the determination of recommended treatments for treating one or more diagnosed medical conditions based on relevant clinical treatment guidelines, the healthcare treatment determination system may, in various embodiments, additionally or alternatively support functionality for the determination of recommended diagnostic test(s)/procedure(s) for diagnosing one or more medical conditions based on relevant diagnostic guidelines.

In accordance with one or more embodiments of the disclosure, the healthcare treatment determination system may receive healthcare data associated with a patient from a healthcare provider system. In certain embodiments, the healthcare treatment determination system may receive the healthcare data from an electronic medical records (EMR) subsystem associated with the healthcare provider system (e.g., an EMR application executing on one or more healthcare provider computers of the healthcare provider system). The healthcare treatment determination system may “pull” the healthcare data from the EMR subsystem or the EMR subsystem may “push” the healthcare data to the healthcare treatment determination system. The healthcare data may include information identifying one or more medical conditions that have been diagnosed for the patient (e.g., hypertension, diabetes, a particular type of cancer, etc.), one or more metrics indicative of a health status associated with the patient (e.g., test results), information identifying one or more symptoms with which the patient has presented (e.g., nausea, vomiting, fever over a specified period of time, percentage of weight loss over a specified time period, etc.), and/or any other evidence-based data that may be obtained from a clinical guideline or clinical evidence data source.

In various embodiments, a healthcare treatment selection subsystem may be provided as part of the healthcare provider system. The healthcare treatment selection subsystem may include a healthcare treatment selection application (e.g., a physician order entry software application) that provides one or more user interfaces for displaying healthcare data associated with a patient and for receiving input from a healthcare provider indicative of one or more healthcare treatments selected by the healthcare provider for administration to the patient. In certain embodiments, the EMR subsystem may be configured to communicate the healthcare data to the healthcare treatment determination system in association with interaction between a healthcare provider and the healthcare treatment selection application. In other embodiments, such as those in which the healthcare provider system does not include an EMR subsystem, the healthcare provider system may be configured to communicate the healthcare data to the healthcare treatment determination system via any suitable mechanism such as, for example, via one or more Application Programming Interfaces (APIs).

In accordance with one or more embodiments of the disclosure, the healthcare treatment determination system may include a healthcare treatment model generation subsystem configured to generate one or more healthcare treatment models based on respective sets of clinical treatment guidelines. For example, the healthcare treatment model generation subsystem may include one or more computer-executable modules configured to utilize a domain specific language to generate a computer-executable healthcare treatment model from a set of clinical treatment guidelines. The healthcare treatment model may include one or more decision trees comprising various decision nodes representative of a series of determinations to be made in analyzing patient healthcare data and arriving at a healthcare treatment that is compliant with the clinical guidelines. While healthcare treatment models generated in accordance with methodologies described herein may be described in the context of decision trees, it should be appreciated that such healthcare treatment models may take on any suitable form that supports the determination of treatment regimens that are in compliance with established clinical guidelines.

In accordance with one or more embodiments of the disclosure, the healthcare treatment determination subsystem may further include a healthcare treatment selection support subsystem. Upon receipt of healthcare data associated with a patient, the healthcare treatment selection support subsystem may identify an appropriate healthcare treatment model for analyzing the received patient healthcare data. In certain embodiments, one or more diagnosed medical conditions associated with the patient may be identified from the patient healthcare data and a healthcare treatment model generated based on clinical treatment guidelines associated with at least one of the medical condition(s) may be identified. The healthcare treatment selection support subsystem may include one or more program modules comprising computer-executable instructions for analyzing the healthcare data based on the identified healthcare treatment model.

In certain embodiments, initial patient healthcare data that is received by the healthcare treatment determination system may be sufficient to identify at least one recommended healthcare treatment based on the identified healthcare treatment model. In various embodiments, the at least one recommended healthcare treatment may be directly identified from an analysis of the received patient healthcare data based on the identified healthcare treatment model. In other embodiments, additional patient healthcare data may be derived or inferred from the received healthcare data and the at least one recommended healthcare treatment may be determined based on the received healthcare data and the additional derived healthcare data. For example, in certain embodiments of the disclosure, one or more clinical rules may be provided that specify various determinations that may be made if one or more criteria are determined to be satisfied by the patient healthcare data. In certain embodiments, upon a determination that the patient healthcare data received from the healthcare provider system satisfies one or more criteria associated with one or more clinical rules, additional patient healthcare data may be derived or inferred from the received patient healthcare data. The additional patient healthcare data may be indicative of one or more characteristics associated with a health status of the patient and/or characteristic(s) associated with one or more diagnosed medical conditions of the patient.

In certain embodiments, the patient healthcare data received from the healthcare provider system and any additional patient healthcare data that may be derived or inferred based on clinical rule(s) may be insufficient to determine a recommended healthcare treatment based on the healthcare treatment model. In such embodiments, the healthcare treatment determination system may communicate a request for additional patient healthcare data to the healthcare provider system. The additional patient healthcare data may include any data required to make further determinations with respect to a health status of the patient, the presence or absence of one or more characteristics associated with the patient's medical condition(s), or the like, in order to ultimately arrive at a recommended healthcare treatment that complies with established clinical treatment guidelines.

In certain embodiments, the requested additional patient healthcare data may be received from an EMR subsystem of the healthcare provider system. In other embodiments, an indication of the additional patient healthcare data that is being requested may be presented to a clinician via a user interface of a healthcare treatment selection application executing on the healthcare provider system. The indication may be presented to the clinician dynamically as the clinician utilizes the treatment selection application to select a treatment regimen for the patient. The clinician may, in various embodiments, provide input to the treatment selection application indicative of the requested additional patient healthcare data, which may then be communicated to the healthcare treatment determination system.

As the healthcare treatment determination system (or more specifically the healthcare treatment selection support subsystem) traverses the healthcare treatment model, requests for additional patient healthcare data may be communicated to the healthcare provider system each time the available patient healthcare data (e.g., patient data received from the healthcare provider system and/or derived or inferred patient healthcare data) is insufficient to make a determination that may be required in order to progress through the model. Requests for additional patient healthcare data may be made iteratively until the patient healthcare data available to the healthcare treatment determination system is sufficient to completely traverse the healthcare treatment model and determine a suitable recommended healthcare treatment.

In certain embodiments, the healthcare treatment determination system may include one or more reporting modules that comprises computer-executable instructions for generating various metrics associated with processing performed by the healthcare treatment determination system such as, for example, metrics associated with the generation of healthcare treatment models, metrics indicative of a number and/or nature of recommended healthcare treatments determined by the healthcare treatment selection support subsystem, metrics indicative of how often recommended healthcare treatments are followed by healthcare providers, and so forth. The report generation module(s) may include computer-executable instructions for generating one or more reports including data indicative of generated metrics. In addition, in various embodiments, feedback may be solicited from a healthcare provider in each instance in which the healthcare provider selects a treatment regimen that does not correspond to a recommended healthcare treatment (e.g., a treatment that does not comply with clinical treatment guidelines). The feedback may include a rationale for selecting the alternate treatment, evidence that supports the alternate treatment, and so forth. The report generation module(s) may incorporate the feedback data into reports that are communicated to entities tasked with establishing clinical treatment guidelines, who may then utilize the feedback data to modify, replace, and/or further refine the guidelines. In the event that clinical treatment guidelines are updated based on, for example, feedback received from healthcare providers, healthcare treatment models generated based on such guidelines may correspondingly be updated to reflect the most up-to-date guidelines.

Technical effects and/or advantages of embodiments of the disclosure include, but are not limited to, automated determinations of treatment regimens and/or diagnostic test(s)/procedure(s) that comply with clinical treatment and/or diagnostic guidelines thereby minimizing non-compliance with established guidelines and improving the efficacy of care rendered to healthcare patients, derivation or inference of additional patient healthcare data from received patient healthcare data based on various clinical rules thereby minimizing requests for extraneous patient healthcare data from healthcare providers, dynamic determination and presentation of recommended treatments or recommended diagnostic test(s)/procedure(s) during treatment selection or diagnosis by a healthcare provider, and so forth. It should be appreciated that the above examples of technical effects and/or advantages of embodiments of the disclosure are merely illustrative and not exhaustive.

The above description of the disclosure is merely illustrative and numerous other embodiments are within the scope of this disclosure. The embodiments described above as well as additional embodiments within the scope of this disclosure will be described in greater detail below.

### Illustrative Architecture

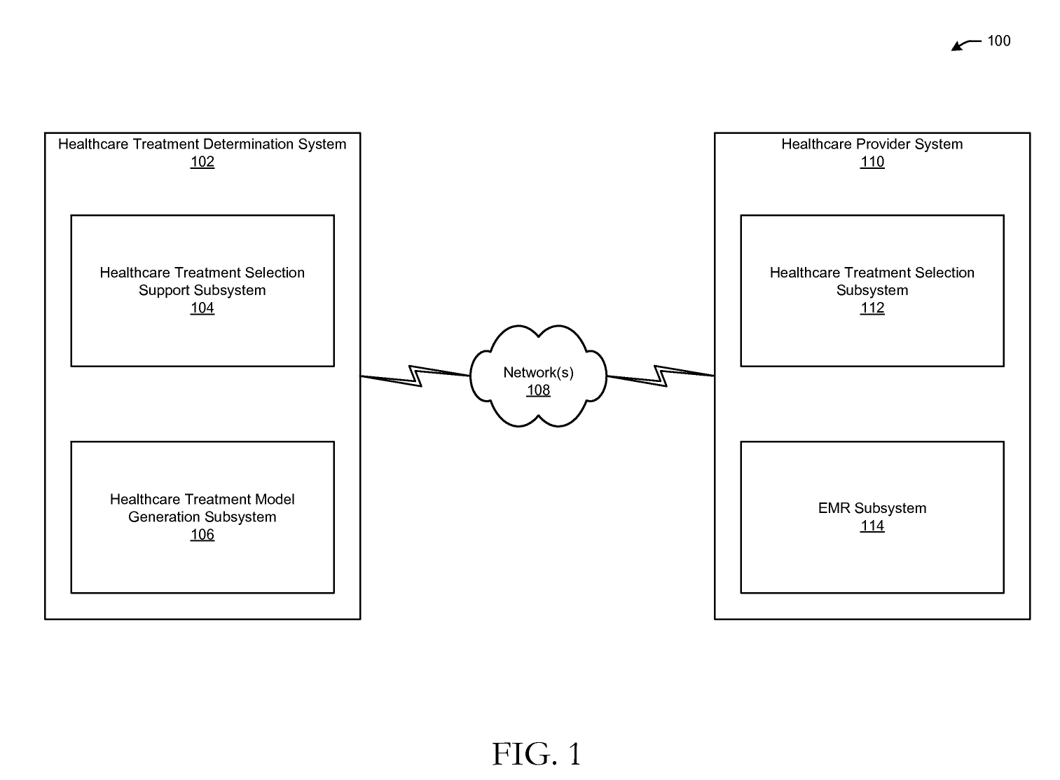

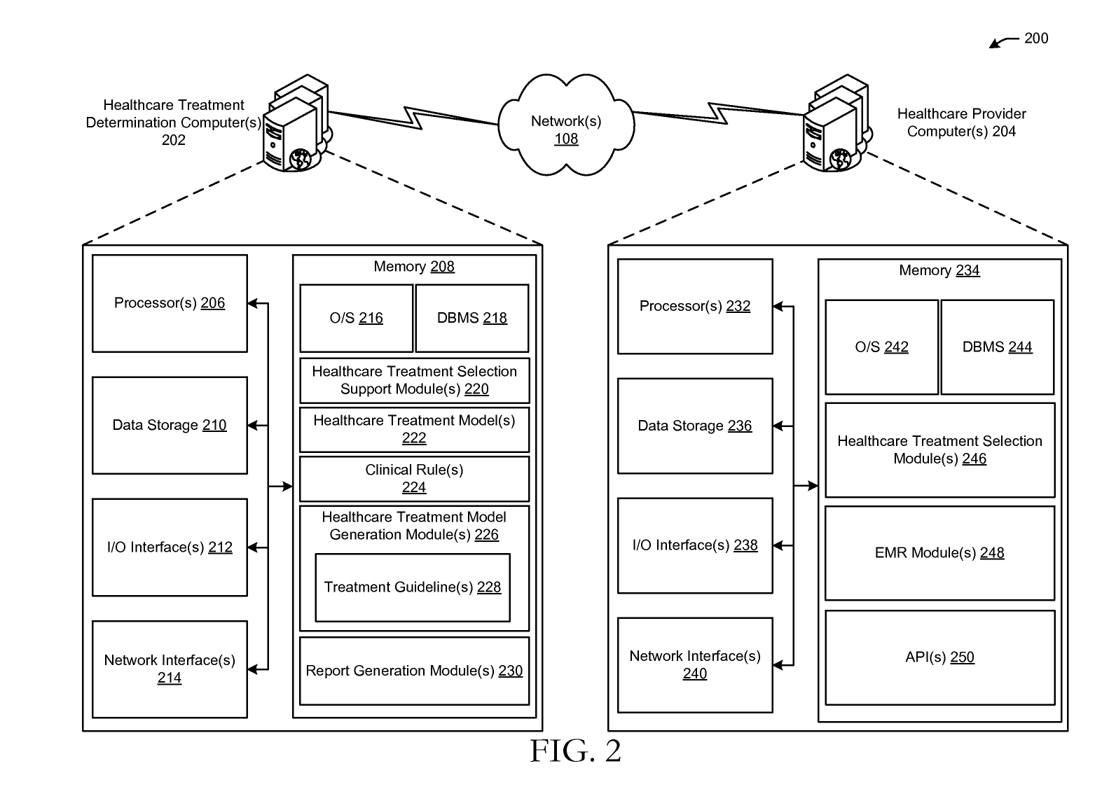

FIG. 1 is a schematic block diagram depicting an illustrative system architecture 100 for determining recommended healthcare treatments based on an analysis of patient healthcare data with respect to a healthcare treatment model associated with relevant clinical treatment guidelines and communicating information identifying the recommended healthcare treatments to a healthcare provider in accordance with one or more embodiments of the disclosure. FIG. 2 is a schematic block diagram depicting, in accordance with one or more embodiments of the disclosure, various illustrative hardware and software components of illustrative computing device(s) of the system architecture 100 depicted in FIG. 1. FIGS. 1 and 2 will be described hereinafter in conjunction with one another.

The illustrative system architecture 100 may include a healthcare treatment determination system 102 that may include various subsystems such as a healthcare treatment selection support subsystem 104 and a healthcare treatment model generation subsystem 106. Each of the subsystems 104, 106 may include a respective set of one or more healthcare treatment determination computers 202 illustratively depicted in FIG. 2. As will be described in more detail hereinafter, the healthcare treatment selection support subsystem 104 may support functionality for identifying a healthcare treatment model associated with a set of clinical treatment guidelines and analyzing patient healthcare data based on the identified healthcare treatment model to determine a recommended healthcare treatment for the patient that complies with the clinical treatment guidelines. Further, as will be described in more detail hereinafter, the healthcare treatment model generation subsystem 106 may support functionality for identifying a set of clinical treatment guidelines for treating one or more medical conditions and generating a computer-executable healthcare treatment model reflective of various determinations that may be made based on patient healthcare data in order to arrive at a recommended healthcare treatment for the patient that complies with the guidelines. It should be appreciated that the subsystems 104, 106 are merely illustrative and that the healthcare treatment determination system 102 may include a fewer or greater number of subsystems capable of supporting additional functionality and/or at least a portion of the respective functionality supported by the subsystem 104 and/or the subsystem 106.

An illustrative healthcare treatment determination computer 202 is depicted in FIG. 2 as including various hardware and/or software components for performing functionality supported by each of the illustrative subsystems 104, 106 of the healthcare treatment determination system 102. However, it should be appreciated that in certain embodiments, respective healthcare treatment determination computer(s) 202 provided as part of a particular subsystem of the healthcare treatment determination system 102 may only be provided with hardware and/or software components for performing respective functionality supported by that particular subsystem. Alternatively, in certain embodiments, functionality supported by any particular subsystem of the healthcare treatment determination system 102 may be distributed, at least in part, across one or more other subsystems. More specifically, in certain embodiments, a healthcare treatment determination computer 202 forming part of a particular subsystem of the healthcare treatment determination system 102 may be configured to perform processing associated with functionality associated with and typically supported by another subsystem. Still further, in certain embodiments, the subsystems 104, 106 may include one or more shared resources (e.g., one or more common healthcare treatment determination computers 202) capable of performing processing associated with functionality supported by the subsystem 104 and/or the subsystem 106.

The healthcare treatment determination system 102 may be configured to communicate with one or more healthcare provider systems 110 (generically referred to herein as healthcare provider system 110) via one or more networks 108. The healthcare provider system 110 may include various subsystems such as a healthcare treatment selection subsystem 112 and an electronic medical records (EMR) subsystem 114. Each of the subsystems 104, 106 may include a respective set of one or more healthcare provider computers 204 illustratively depicted in FIG. 2. As will be described in more detail hereinafter, the healthcare treatment selection subsystem 104 may support functionality for presenting patient healthcare data to a healthcare provider and receiving input from the healthcare provider indicative of one or more healthcare treatments selected for administration to a patient. In certain embodiments, the healthcare treatment selection subsystem 112 may include a healthcare treatment selection application (e.g., a physician order entry software application) that provides one or more user interfaces for presenting healthcare data associated with a patient to a healthcare provider and for receiving input from the healthcare provider indicative of one or more healthcare treatments selected by the healthcare provider for administration to the patient.

The EMR subsystem 114 may support functionality for gathering, generating, storing, and/or communicating to one or more other systems any of a variety of types of patient healthcare data such as, for example, patient medical history information including information relating to patient symptoms documented during clinical visits, information relating to past and/or current healthcare treatments administered to a patient, results of diagnostic test(s)/procedure(s) administered to a patient, and so forth. In certain embodiments, the EMR subsystem 114 may include an EMR application that includes one or more user interfaces for presenting patient healthcare data to a healthcare provider and/or for receiving input from a healthcare provider corresponding to patient healthcare data associated with a patient.

It should be appreciated that the subsystems 112, 114 are merely illustrative and that the healthcare provider system 110 may include a fewer or greater number of subsystems capable of supporting additional functionality and/or at least a portion of the respective functionality supported by the subsystem 112 and/or the subsystem 114. Further, the illustrative healthcare provider computer 204 is depicted in FIG. 2 as including various hardware and/or software components for performing functionality supported by each of the illustrative subsystems 112, 114 of the healthcare provider system 110. However, it should be appreciated that in certain embodiments, respective healthcare provider computer(s) 204 provided as part of a particular subsystem of the healthcare provider system 110 may only be provided with hardware and/or software components for performing respective functionality supported by that particular subsystem. Alternatively, in certain embodiments, functionality supported by any particular subsystem of the healthcare provider system 110 may be distributed, at least in part, across one or more other subsystems. More specifically, in certain embodiments, a healthcare provider computer 204 forming part of a particular subsystem of the healthcare provider system 110 may be configured to perform processing associated with functionality that is associated with and typically supported by another subsystem. Still further, in certain embodiments, the subsystems 112, 114 may include one or more shared resources (e.g., one or more common healthcare provider computers 204) capable of performing processing associated with functionality supported by the subsystem 112 and/or the subsystem 114.

The network(s) 108 via which the healthcare treatment determination system 102 and the healthcare provider system 110 may be configured to communicate may include any one or a combination of different types of suitable communications networks such as, for example, cable networks, public networks (e.g., the Internet), private networks, wireless networks, cellular networks, or any other suitable private and/or public networks. Further, the network(s) 108 may have any suitable communication range associated therewith and may include, for example, global networks (e.g., the Internet), metropolitan area networks (MANs), wide area networks (WANs), local area networks (LANs), or personal area networks (PANs). In addition, the network(s) 108 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof. In certain embodiments, the healthcare treatment determination system 102 and the healthcare provider system 110 may be configured to exchange information in accordance with a client-server system architecture such as, for example, a Representational State Transfer (REST) web services architecture.

Still referring to FIGS. 1 and 2, the illustrative healthcare treatment determination computer(s) 202 may include any suitable processor-driven device including, but not limited to, a server computer, a desktop computer, a laptop computer, a mainframe computer, a workstation, a mobile computing device, and so forth. Each of the healthcare treatment determination computer(s) 202 may include one or more processors (processor(s)) 206, one or more memory devices 208 (generically referred to herein as memory 208), data storage 210, one or more input/output (“I/O”) interface(s) 212, and/or one or more network interface(s) 214. For ease of explanation, the healthcare treatment determination computer(s) 202 will be referred to hereinafter in the singular. However, it should be appreciated that multiple healthcare treatment determination computers 202 may be provided as part of the healthcare treatment determination system 102.

The memory 208 of the healthcare treatment determination computer 202 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 208 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 208 may store computer-executable instructions that are loadable and executable by the processor(s) 206, as well as data manipulated and/or generated by the processor(s) 206 during the execution of the computer-executable instructions. For example, the memory 208 may store one or more operating systems (O/S) 216; one or more database management systems (DBMS) 218; one or more program modules such as one or more healthcare treatment selection support modules 220, one or more healthcare treatment model generation modules 226, one or more report generation modules 230, and so forth; and/or various other types of data and/or computer-executable instructions such as one or more healthcare treatment models 222, one or more clinical rules 224, one or more sets of clinical treatment guideline(s) 228, and so forth. The various illustrative program modules depicted as being loaded into the memory 208 may include computer-executable instructions that responsive to execution by the processor(s) 206 cause various processing to be performed. In order to perform such processing, the program modules may utilize, at least in part, data stored in the memory 208, data stored in the data storage 210, and/or data stored in one or more datastores provided externally to the healthcare treatment determination computer 202 (not shown).

The (O/S) 216 loaded into the memory 208 may provide an interface between other application software executing on the healthcare treatment determination computer 202 and the hardware resources of the healthcare treatment determination computer 202. More specifically, the O/S 216 may include a set of computer-executable instructions for managing hardware resources of the healthcare treatment determination computer 202 and for providing common services to other application programs (e.g., managing memory allocation among various application programs). The O/S 216 may include any operating system now known or which may be developed in the future including, but not limited to, any server operating system, any desktop or laptop operating system, any mainframe operating system, any mobile operating system, or any other proprietary or freely available operating system.

As previously noted, the healthcare treatment determination computer 202 may further include data storage 210 such as removable storage and/or non-removable storage including, but not limited to, magnetic storage, optical disk storage, and/or tape storage. Data storage 210 may provide non-transient storage of computer-executable instructions and other data. The data storage 210 may include storage that is internal and/or external to the healthcare treatment determination computer 202. The memory 208 and/or the data storage 210, removable and/or non-removable, are examples of computer-readable storage media (CRSM) as that term is used herein.

It should be appreciated that any data and/or computer-executable instructions stored in the memory 208 may be additionally, or alternatively, stored in the data storage 210 and/or one or more external datastores (not shown). The DBMS 218 depicted as being loaded into the memory 208 may support functionality for accessing, retrieving, storing, and/or manipulating data stored in external datastore(s), data stored in the memory 208, and/or data stored in the data storage 210. The DBMS 218 may use any of a variety of database models (e.g., relational model, object model, etc.) and may support any of a variety of query languages.

The processor(s) 206 may be configured to access the memory 208 and execute computer-executable instructions stored therein. For example, the processor(s) 206 may be configured to execute computer-executable instructions of the various program modules of the healthcare treatment determination computer 202 to cause or facilitate various operations to be performed in accordance with one or more embodiments of the disclosure. The processor(s) 206 may include any suitable processing unit capable of accepting digital data as input, processing the input data in accordance with stored computer-executable instructions, and generating output data. The processor(s) 206 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

As previously noted, the healthcare treatment determination computer 202 may further include one or more I/O interfaces 212 that may facilitate the receipt of input information by the healthcare treatment determination computer 202 from one or more I/O devices as well as the output of information from the healthcare treatment determination computer 202 to the one or more I/O devices. The I/O devices may include, for example, one or more user interface devices that facilitate interaction between a user and the healthcare treatment determination computer 202 including, but not limited to, a display, a keypad, a pointing device, a control panel, a touch screen display, a remote control device, a microphone, a speaker, and so forth.

As previously noted, the healthcare treatment determination system 102 (or more specifically one or more of the healthcare treatment determination computers 202) may be configured to communicate with any of a variety of other systems, platforms, devices, and so forth (e.g., the healthcare provider system 110) via one or more of the network(s) 108. The healthcare treatment determination computer 202 may include one or more network interfaces 214 that may facilitate communication between the healthcare treatment determination computer 202 and any of the above-mentioned systems, platforms or devices via one or more of the network(s) 108.

Referring now to the healthcare provider system 110, one or more healthcare provider computers 204 illustratively depicted in FIG. 2 may be provided as part of the healthcare provider system 110. The healthcare provider computer(s) 204 may include any suitable processor-driven device including, but not limited to, a server computer, a desktop computer, a laptop computer, a mainframe computer, a workstation, a mobile computing device, and so forth. Each of the healthcare provider computer(s) 204 may include one or more processors (processor(s)) 232, one or more memory devices 234 (generically referred to herein as memory 234), data storage 236, one or more input/output (“I/O”) interface(s) 238, and/or one or more network interface(s) 240. For ease of explanation, the healthcare provider computer(s) 204 will be referred to hereinafter in the singular. However, it should be appreciated that multiple healthcare provider computers 204 may be provided as part of the healthcare provider system 110.

The memory 234 of the healthcare provider computer 204 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 234 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 234 may store computer-executable instructions that are loadable and executable by the processor(s) 232, as well as data manipulated and/or generated by the processor(s) 232 during the execution of the computer-executable instructions. For example, the memory 234 may store one or more operating systems (O/S) 242; one or more database management systems (DBMS) 244; one or more program modules such as one or more healthcare treatment selection modules 246, one or more EMR modules 248, one or more Application Programming Interfaces (APIs) 250, and so forth; and/or various other types of data and/or computer-executable instructions. The various illustrative program modules depicted as being loaded into the memory 234 may include computer-executable instructions that responsive to execution by the processor(s) 232 cause various processing to be performed. In order to perform such processing, the program modules may utilize, at least in part, data stored in the memory 234, data stored in the data storage 236, and/or data stored in one or more datastores provided externally to the healthcare provider computer 204 (not shown).

The (O/S) 242 loaded into the memory 234 may provide an interface between other application software executing on the healthcare provider computer 204 and the hardware resources of the healthcare provider computer 204. More specifically, the O/S 242 may include a set of computer-executable instructions for managing hardware resources of the healthcare provider computer 204 and for providing common services to other application programs (e.g., managing memory allocation among various application programs). The O/S 242 may include any operating system now known or which may be developed in the future including, but not limited to, any server operating system, any desktop or laptop operating system, any mainframe operating system, any mobile operating system, or any other proprietary or freely available operating system.

As previously noted, the healthcare provider computer 204 may further include data storage 236 such as removable storage and/or non-removable storage including, but not limited to, magnetic storage, optical disk storage, and/or tape storage. Data storage 236 may provide non-transient storage of computer-executable instructions and other data. The data storage 236 may include storage that is internal and/or external to the healthcare provider computer 204. The memory 234 and/or the data storage 236, removable and/or non-removable, are examples of computer-readable storage media (CRSM) as that term is used herein.

It should be appreciated that any data and/or computer-executable instructions stored in the memory 234 may be additionally, or alternatively, stored in the data storage 236 and/or one or more external datastores (not shown). The DBMS 244 depicted as being loaded into the memory 234 may support functionality for accessing, retrieving, storing, and/or manipulating data stored in external datastore(s), data stored in the memory 234, and/or data stored in the data storage 236. The DBMS 244 may use any of a variety of database models (e.g., relational model, object model, etc.) and may support any of a variety of query languages.

The processor(s) 232 may be configured to access the memory 234 and execute computer-executable instructions stored therein. For example, the processor(s) 232 may be configured to execute computer-executable instructions of the various program modules of the healthcare provider computer 204 to cause or facilitate various operations to be performed in accordance with one or more embodiments of the disclosure. The processor(s) 232 may include any suitable processing unit capable of accepting digital data as input, processing the input data in accordance with stored computer-executable instructions, and generating output data. The processor(s) 232 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

As previously noted, the healthcare provider computer 204 may further include one or more I/O interfaces 238 that may facilitate the receipt of input information by the healthcare provider computer 204 from one or more I/O devices as well as the output of information from the healthcare provider computer 204 to the one or more I/O devices. The I/O devices may include, for example, one or more user interface devices that facilitate interaction between a user and the healthcare provider computer 204 including, but not limited to, a display, a keypad, a pointing device, a control panel, a touch screen display, a remote control device, a microphone, a speaker, and so forth.

The healthcare provider system 110 (or more specifically one or more of the healthcare provider computers 204) may be configured to communicate with any of a variety of other systems, platforms, devices, and so forth (e.g., the healthcare treatment determination system 102) via one or more of the network(s) 108. As previously noted, the healthcare provider computer 204 may include one or more network interfaces 240 that may facilitate communication between the healthcare provider computer 204 and any of the above-mentioned systems, platforms or devices via one or more of the network(s) 108.

Referring again to the various illustrative program modules depicted as forming part of the healthcare treatment determination computer 202, the healthcare treatment model generation module(s) 226 may include computer-executable instructions for receiving a set of clinical treatment guidelines(s) 228 associated with one or more medical conditions as input and generating a healthcare treatment model 222 representative of the treatment guideline(s). In certain embodiments, a respective healthcare treatment model 222 may be generated for each set of clinical treatment guideline(s) associated with a particular medical condition or a group of related medical conditions. As a non-limiting example, a set of clinical treatment guidelines for treating one or more types of cancer may be promulgated by a guideline body. The healthcare treatment model generation module(s) 226 may utilize a domain specific language (DSL) to generate a suitable healthcare treatment model 222 from the set of clinical treatment guidelines for treating the one or more types of cancer. Healthcare treatment model(s) 222 generated in accordance with embodiments of the disclosure may take on any suitable form that facilitates automated processing of patient healthcare data to determine recommended healthcare treatments that comply with treatment guideline(s) for medical condition(s) associated with patients.

The healthcare treatment selection module(s) 220 may include computer-executable instructions for receiving patient healthcare data associated with a patient as input, identifying an appropriate healthcare treatment model 222 associated with clinical treatment guidelines 228 relevant to one or more medical conditions associated with the patient, and analyzing the patient healthcare data in relation to the healthcare treatment model 222 to identify a treatment regimen (e.g., one or more recommended healthcare treatments) to be administered to the patient. In certain embodiments, the patient healthcare data may be received from the healthcare provider system 110 (e.g., the EMR subsystem 114 and/or the healthcare treatment selection subsystem 112) or from one or more other external systems. In various embodiments, the healthcare treatment selection module(s) 220 may include computer-executable instructions for identifying one or more medical conditions that the patient has been diagnosed with based on information included in the patient healthcare data and may identify an appropriate healthcare treatment model 222 associated with clinical treatment guidelines 228 for treating at least one of the one or more medical conditions.

In certain embodiments, the healthcare treatment model(s) 222 may include various decision tree(s) comprising decision nodes that specify various determinations that may need to be made in order to determine an appropriate recommended treatment regimen. The determination associated with any particular decision node may correspond to a determination as to whether one or more characteristics associated with a medical condition diagnosed for a patient are present or absent, a determination as to whether one or more criteria associated with a health status of the patient are satisfied or not, and so forth. The healthcare treatment selection module(s) 220 may include computer-executable instructions for parsing or otherwise analyzing patient healthcare data to facilitate making determinations associated with the various decision nodes of the healthcare treatment model 222.

In accordance with one or more embodiments of the disclosure, the healthcare treatment determination system 102 (or more specifically the healthcare treatment selection support module(s) 220) may receive patient healthcare data associated with a patient from the healthcare provider system 110. In certain embodiments, the patient healthcare data may be received from one or more EMR modules 248 forming part of the EMR subsystem 114. In various embodiments, the EMR module(s) 248 may form part of an EMR application that is executable on one or more healthcare provider computers 204. The EMR application may include one or more user interfaces for presenting patient data to a healthcare provider and/or for receiving patient data as input from the healthcare provider.

One or more healthcare treatment selection modules 246 may also be provided as part of the healthcare provider system 110. In certain embodiments, the healthcare treatment selection module(s) 246 may form part of a healthcare treatment selection application (e.g., a physician order entry software application) executable on one or more healthcare provider computers 204. The healthcare treatment selection module(s) 246 may include one or more user interfaces for presenting healthcare data associated with a patient to a healthcare provider and for receiving input from the healthcare provider indicative of one or more healthcare treatments selected by the healthcare provider for administration to the patient. In certain embodiments, the EMR module(s) 248 may be configured to independently communicate the patient healthcare data to the healthcare treatment selection support module(s) 220 concurrently with interaction between a healthcare provider and the healthcare treatment selection module(s) 246. In other embodiments, such as those in which the healthcare provider system 110 does not include the EMR subsystem 114 or the like, the healthcare treatment selection module(s) 246 and/or other program module(s) of the healthcare provider computer 204 may be configured to communicate patient healthcare data to the healthcare treatment determination system 102 using one or more APIs 250 or any other suitable mechanism for interfacing with the healthcare treatment determination system 102.

In certain embodiments, patient healthcare data initially received by the healthcare treatment determination system 102 may be sufficient for the healthcare treatment selection support module(s) 220 to identify at least one recommended healthcare treatment based on the identified healthcare treatment model 222. In various embodiments, the at least one recommended healthcare treatment may be directly identified from an analysis of the received patient healthcare data based on the identified healthcare treatment model 222, while in other embodiments, additional patient healthcare data may be derived from the received healthcare data and the at least one recommended healthcare treatment may be determined based on the received healthcare data and the additional derived healthcare data. For example, in certain embodiments, one or more clinical rules 224 may be provided that may specify various determinations that may be made if one or more criteria are met by the patient healthcare data. More specifically, the clinical rule(s) 224 may specify additional patient data associated with a patient's health status, one or more medical conditions with which the patient has been diagnosed, or the like that may be inferred from existing patient data. In certain embodiments, additional patient data may be derived or inferred from a combination of patient facts indicated by the existing patient healthcare data and based on which one or more criteria of clinical rule(s) for establishing the additional patient data may be determined to be satisfied.

In certain embodiments, the patient healthcare claim data received from the healthcare provider system 110 and any additional patient healthcare data that may be derived or inferred based on clinical rule(s) 224 may be insufficient to determine a recommended healthcare treatment based on the healthcare treatment model 222. In such embodiments, the healthcare treatment selection support module(s) 220 may generate a request for additional patient healthcare data, which may be communicated to the healthcare provider system 110. The additional patient healthcare data may include any data required to make further determinations with respect to a health status of the patient, the presence or absence of one or more characteristics associated with the patient's medical condition(s), or the like, in order to ultimately arrive at a recommended healthcare treatment that complies with established clinical treatment guidelines.

In certain embodiments, the requested additional patient healthcare data may be received by the healthcare treatment determination system 102 from the EMR module(s) 248. In other embodiments, an indication of the additional patient healthcare data that is being requested may be displayed to a clinician via a user interface provided by the healthcare treatment selection module(s) 246. The indication may be presented to the clinician dynamically (e.g., as a pop-up window) from a user interface presented by the healthcare treatment selection module(s) 246 and via which the clinician may provide input indicative of the requested additional healthcare data, which may then may communicated to the healthcare treatment selection support module(s) 220 of the healthcare treatment determination system 102.

As the identified healthcare treatment model 222 is traversed, requests for additional patient healthcare data may be communicated to the healthcare provider system 110 each time the available patient healthcare data (e.g., patient data received from the healthcare provider system 110 and/or derived or inferred patient data) is insufficient to make a determination that may be required in order to progress through the model. Requests for additional patient healthcare data may be made iteratively until the patient healthcare data available to the healthcare treatment selection support module(s) 220 is sufficient to completely traverse the healthcare treatment model 222 and determine a suitable recommended healthcare treatment.

In accordance with one or more embodiments of the disclosure, the report generation module(s) 230 may include computer-executable instructions for generating various metrics associated with processing performed by the healthcare treatment determination system 102 such as, for example, metrics associated with the generation of healthcare treatment models 222, metrics indicative of a number and/or nature of recommended healthcare treatments determined by the healthcare treatment selection support subsystem 104, metrics indicative of the extent to which healthcare treatments selected by healthcare providers for administering to patients comply with relevant clinical treatment guidelines (e.g., the extent to which recommended healthcare treatments are followed by healthcare providers), and so forth. The report generation module(s) 230 may include computer-executable instructions for generating one or more reports including data indicative of generated metrics. The generated report(s) may be communicated to any suitable entity such as, for example, entities tasked with promulgating clinical treatment guidelines, healthcare providers, and so forth.

In addition, in various embodiments, feedback may be solicited from a healthcare provider in each instance in which the healthcare provider selects a treatment regimen that does not correspond to a recommended healthcare treatment (e.g., an alternate treatment that does not comply with clinical treatment guidelines). In certain embodiments, the healthcare provider may provide input to the healthcare treatment selection module(s) 246 indicative of the requested feedback, which may then be communicated to the healthcare treatment determination system 102. The feedback may include a rationale for selecting the alternate treatment, evidence that supports the alternate treatment, and so forth. The report generation module(s) 230 may incorporate the feedback data received from the healthcare provider system 110 into reports that are communicated to entities tasked with establishing clinical treatment guidelines, who may then utilize the feedback data to modify, replace, and/or further refine the guidelines. In the event that clinical treatment guidelines are updated based on, for example, feedback received from healthcare providers, healthcare treatment model(s) 222 generated based on such guidelines may correspondingly be updated to reflect the most up-to-date guidelines.

The various program modules depicted as being loaded into the memory 208 of the healthcare treatment determination computer 202 may form part of respective subsystems (e.g., subsystems 104, 106) of the healthcare treatment determination system 102. For example, the healthcare treatment selection support module(s) 220 may be executable on one or more healthcare treatment determination computers 202 forming part of the healthcare treatment selection support subsystem 104. Similarly, the healthcare treatment model generation module(s) 226 may be executable on one or more healthcare treatment determination computers 202 forming part of the healthcare treatment model generation subsystem 106. The report generation module(s) 230 may be executable on one or more healthcare treatment determination computers 202 forming part of the subsystem 104, the subsystem 106, and/or one or more other subsystems of the healthcare treatment determination system 102. Similarly, the various program modules depicted as being loaded into the memory 234 of the healthcare provider computer 202 may form part of respective subsystems (e.g., subsystems 112, 114) of the healthcare provider system 110.

As previously noted, while various embodiments of the disclosure may be described herein in the context of the determination and selection of recommended healthcare treatments for treating one or more medical conditions of a patient, it should be appreciated that embodiments of the disclosure are equally applicable to the determination and selection of diagnostic test(s)/procedure(s) for diagnosing one or more medical conditions for a patient. More specifically, in addition to supporting functionality for the determination of recommended treatments for treating one or more diagnosed medical conditions based on relevant clinical treatment guidelines, the healthcare treatment determination system 102 (and hardware and software components thereof) may, in various embodiments, additionally or alternatively support functionality for the determination of recommended diagnostic test(s)/procedure(s) for diagnosing one or more medical conditions based on relevant diagnostic guidelines.

It should be appreciated that the systems, subsystems, computers, and associated hardware and software components depicted in FIGS. 1 and 2 are merely illustrative and that, in certain embodiments, a lesser number or a greater number of systems, subsystems, computers, and/or associated hardware and software components than those depicted may be provided. It should further be appreciated that, in certain embodiments, functionality described as being supported by a particular subsystem, program module, or the like may be distributed across multiple subsystems, program modules, or the like.

Those of ordinary skill in the art will appreciate that the healthcare treatment determination system 102 and/or the healthcare provider system 110 may include any number of alternate and/or additional hardware, software, or firmware components beyond those described or depicted without departing from the scope of the disclosure. More particularly, it should be appreciated that software, firmware, or hardware components depicted or described as forming part of the healthcare treatment determination system 102 and/or the healthcare provider system 110 and the respective computing devices 202, 204 forming part of such systems, as well as the associated functionality that such components or sub-components included therein are described as supporting, are merely illustrative and that some components may not be present and/or additional components may be provided in various embodiments. While various program modules have been depicted and described, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of the software, firmware, and/or hardware for implementing the functionality. Accordingly, it should be appreciated that the functionality described as being provided by a particular module may, in various embodiments, be provided, at least in part, by one or more other modules. Further, one or more depicted modules may not be present in certain embodiments, while in other embodiments, additional modules not depicted may be present and may support at least a portion of the described functionality and/or additional functionality. Further, while certain program modules may be depicted and described as sub-modules of another program module, such modules may be provided as independent modules in certain embodiments.

Those of ordinary skill in the art will appreciate that the illustrative healthcare treatment determination system 102 and the illustrative healthcare provider system 110 depicted in abstracted form in FIG. 1 and the more detailed depictions of illustrative computing devices thereof in FIG. 2 are provided by way of example only. Numerous other operating environments, system architectures, and device configurations are within the scope of this disclosure. Other embodiments of the disclosure may include fewer or greater numbers of components and/or devices and may incorporate some or all of the functionality described herein, or additional functionality.

### Illustrative Processes

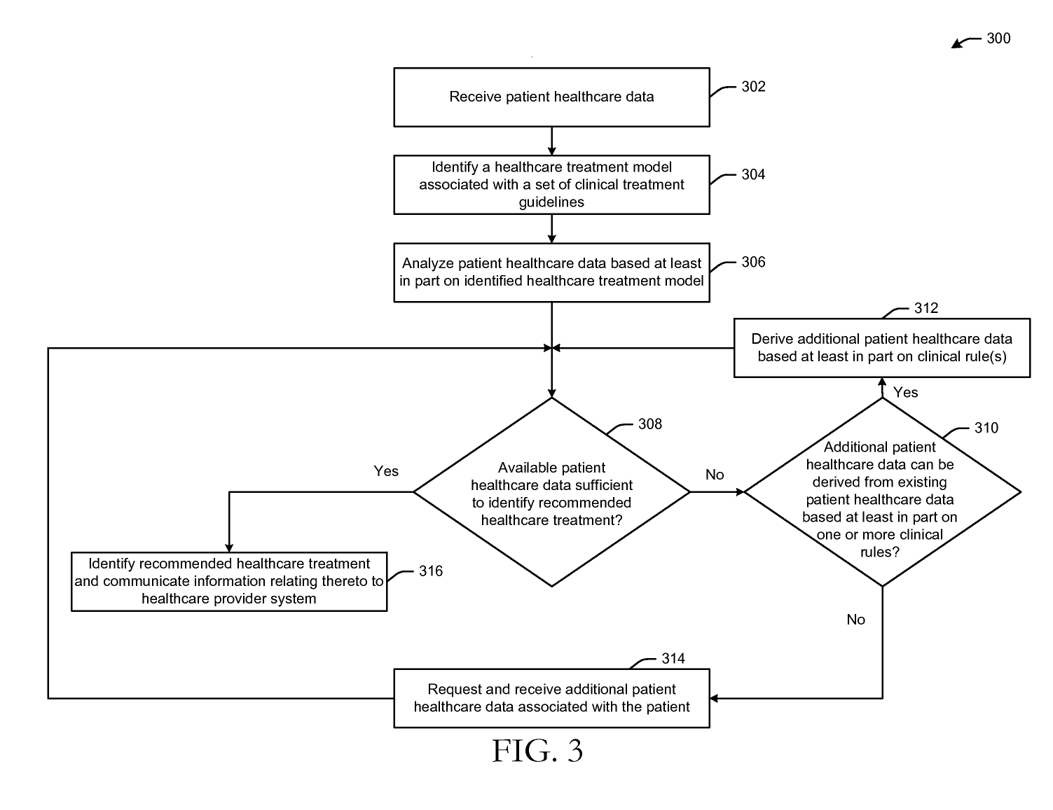

FIG. 3 is a process flow diagram of an illustrative method 300 for determining recommended healthcare treatments based on an analysis of patient healthcare data with respect to a healthcare treatment model associated with relevant clinical treatment guidelines and communicating information identifying the recommended healthcare treatments to a healthcare provider in accordance with one or more embodiments of the disclosure. One or more operations of the illustrative method 300 may be performed responsive to execution of computer-executable instructions of one or more program modules (e.g., the healthcare treatment selection module(s) 220) executing on one or more healthcare treatment determination computers 202 of the healthcare treatment determination system 102.

At block 302, patient healthcare data may be received by the healthcare treatment determination system 102 from, for example, a healthcare provider system 110. The received patient healthcare data may include any healthcare data associated with a patient including, but not limited to, patient medical history information including information relating to patient symptoms documented during clinical visits, information relating to past and/or current healthcare treatments administered to the patient, results of diagnostic test(s)/procedure(s) administered to the patient, data relating to one or more diagnosed medical conditions of the patient, and so forth.

At block 304, a healthcare treatment model associated with a set of clinical treatment guidelines may be identified. The healthcare treatment model identified at block 304 may have been previously generated by the healthcare treatment model generation module(s) 226 based on the set of clinical treatment guidelines. In certain embodiments, information identifying a medical condition associated with the patient (e.g., a particular type of cancer that the patient has been diagnosed with) may be identified from the received patient healthcare data and a healthcare treatment model that is associated with clinical treatment guidelines that specify an established protocol for treating the medical condition may be identified.

At block 306, the received patient healthcare data may be analyzed based on the identified healthcare treatment model. More specifically, computer-executable instructions provided as part of the healthcare treatment selection support module(s) 220 may be executed to make various clinical determinations associated with various decision nodes of the healthcare treatment model based on the received patient healthcare data.

In certain embodiments, blocks 308-314 of the method 300 may represent iterative processing that may be performed until the healthcare treatment model is traversed and at least one recommended healthcare treatment is identified. At block 308, a determination may be made as to whether the received patient healthcare data and/or any patient healthcare data derived from the received patient data is sufficient to make all decision node determinations necessary to identify a recommended healthcare treatment. At an initial iteration in the iterative processing of blocks 308-314, a determination may not yet have been made as to whether additional patient healthcare data can be derived from received healthcare data. Accordingly, at an initial iteration, the determination may be made with respect to received healthcare data alone.

In response to a negative determination at block 308, the method 300 may proceed to block 310 where a determination may be made as to whether additional patient healthcare data can be derived or inferred from the received patient healthcare data based on one or more clinical rules. If it is determined at block 310 that additional patient healthcare data can be derived based on clinical rule(s), the additional data may be derived or inferred at block 312. The derivation or inference of additional patient healthcare data may occur upon a determination that the patient healthcare data satisfies one or more criteria of one or more clinical rules.

Upon derivation or inference of additional patient healthcare data at block 312, the method 300 may again proceed to block 308 where a determination may again be made as to whether received patient healthcare data and any derived additional patient healthcare data are sufficient to identify at least one recommended healthcare treatment. If the available patient healthcare data (e.g., received and/or derived patient healthcare data) is sufficient, the method 300 may proceed to block 316 where at least one recommended healthcare treatment may be identified and information identifying the at least one recommended healthcare treatment may be communicated to a healthcare provider system for presentation to a healthcare provider. In this manner, selection by the healthcare provider of healthcare treatments that are compliant with clinical treatment guidelines may be facilitated.

On the other hand, if it is determined at block 308 that the available patient healthcare data is not sufficient to identify at least one recommended healthcare treatment, and it is further determined at block 310 that no additional patient healthcare data can be derived, the method 300 may proceed to block 314 where additional patient healthcare data may be requested. More specifically, upon determining that the available patient healthcare data is insufficient to traverse the healthcare treatment model and identify at least one recommended healthcare treatment, the healthcare selection support module(s) 220 may generate a request for additional patient healthcare data which may be, in turn, communicated to the healthcare provider system from which the patient healthcare data was initially received. As previously described, the healthcare treatment determination system 102 may receive the requested additional patient healthcare data from an EMR subsystem (e.g., an EMR application) of the healthcare provider system, from a treatment selection application executing on a healthcare provider computer 202 of the healthcare provider system 110 (potentially based on input received from the healthcare provider), or via any other suitable mechanism.

Upon receipt of the requested additional patient healthcare data, the method 300 may again proceed to block 308 where a determination may again be made as to whether available patient healthcare data (including patient data received at block 314 as well as patient data previously received and/or derived) is sufficient to identify at least one recommended treatment. Upon a positive determination at block 308, at least one recommended healthcare treatment may be identified and information relating thereto may be communicated to the healthcare provider system at block 316. On the other hand, upon a negative determination at block 308, the method 300 may proceed to block 310 where a determination may be made as to whether additional patient healthcare data can be derived from existing available patient healthcare data (which may include patient healthcare data received from the healthcare provider system as well as any additional patient healthcare data that has already been derived or inferred). The processing of method 300 may then continue iteratively from the determination at block 310 until patient healthcare data available to the healthcare treatment determination system 102 is sufficient to identify at least one recommended healthcare treatment for the patient that is in compliance with relevant clinical treatment guidelines.

Although not depicted as part of the illustrative method 300, it should be appreciated that in various embodiments, despite a request for additional patient healthcare data, the healthcare treatment determination system 102 may not be provided with healthcare data that is sufficient to identify a recommended healthcare treatment. In such scenarios, the healthcare treatment determination system 102 may communicate an exception message to the healthcare provider system 110 indicating that a recommended healthcare treatment that is compliant with established clinical guidelines could not be identified. Further, as noted above, in certain embodiments various metrics may be generated and reports including data identifying generated metrics may be communicated to any of a variety of entities. For example, metrics indicative of the extent of healthcare provider compliance with recommended healthcare treatments may be generated. Further, feedback data may be solicited from healthcare providers in circumstances in which recommended healthcare treatments are not followed and the feedback data may be communicated to a guideline body for assessment and potential modification of clinical guidelines.

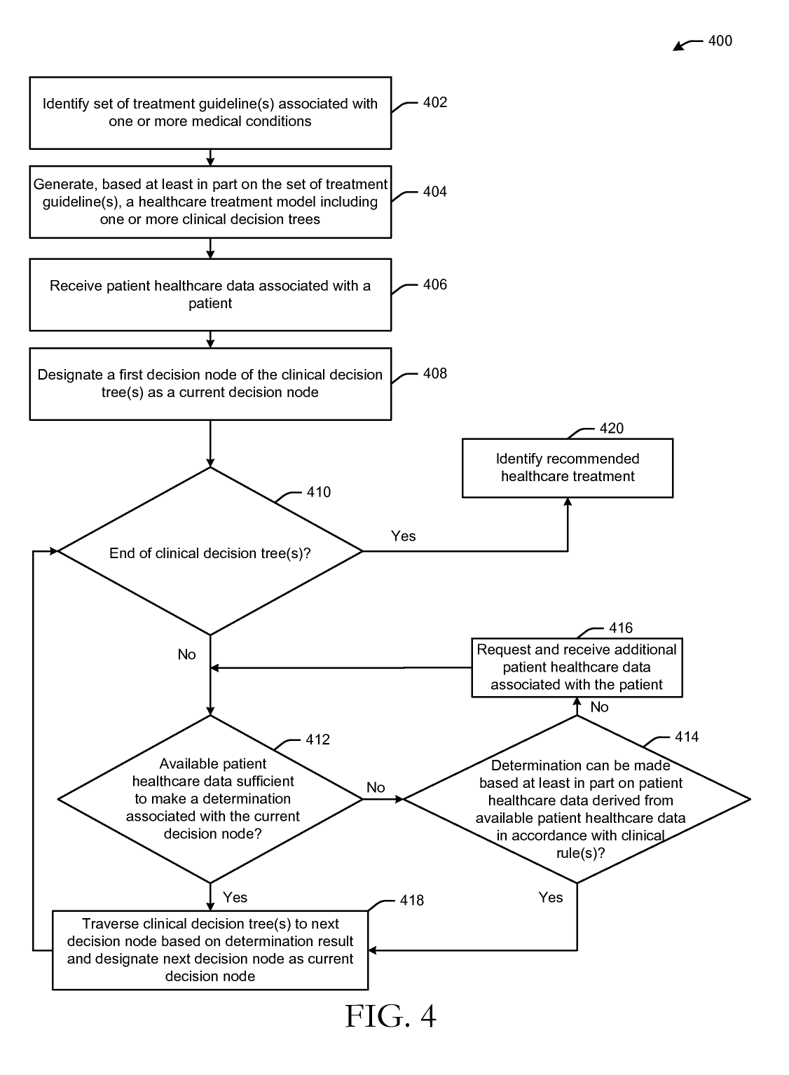

FIG. 4 is a process flow diagram of an illustrative method 400 for generating a healthcare treatment model based on clinical treatment guidelines and traversing clinical decision tree(s) of the healthcare treatment model to identify a recommended healthcare treatment in accordance with one or more embodiments of the disclosure. One or more operations of the illustrative method 400 may be performed responsive to execution of computer-executable instructions of one or more program modules (e.g., the healthcare treatment selection module(s) 220, the healthcare treatment model generation module(s) 226, etc.) executing on one or more healthcare treatment determination computers 202 of the healthcare treatment determination system 102.

At block 402, a set of clinical treatment guidelines associated with one or more medical conditions may be identified. The set of clinical treatment guidelines may have been promulgated by any suitable entity such as, for example, an organization of medical professionals, an expert panel or other committee formed with the express purpose or expressly tasked with establishing such guidelines, a consortium of medical research organizations, and so forth. The set of clinical guidelines may relate to a particular medical condition (e.g., type II diabetes) or to a related group of medical conditions (e.g., lymphomas of various types).

At block 404, a healthcare treatment model may be generated based on the set of clinical treatment guidelines identified at block 402. More specifically, computer-executable instructions provided as part of the healthcare treatment model generation module(s) 226 may be executed to receive guideline content of the set of clinical treatment guidelines as input and to construct a computer-executable healthcare treatment model representative of decision processing that may be performed in order to identify healthcare treatments that are in compliance with the clinical treatment guidelines. In certain embodiments, the healthcare treatment model may include one or more clinical decision trees that embody the decision processing of the clinical treatment guidelines.

At block 406, the healthcare treatment determination system 102 may receive patient healthcare data associated with a patient from the healthcare provider system 104 or any other suitable entity. The patient healthcare data may be received in accordance with any of the mechanisms previously described. It should be appreciated that in certain embodiments the processing of blocks 402-404 and the processing of blocks 406-420 may not be performed in the sequential manner depicted. Rather, in certain embodiments, the set of clinical treatment guidelines may be identified and the healthcare treatment model may be dynamically generated upon or subsequent to receipt of the patient healthcare data. Further, in other embodiments, the healthcare treatment model may have been generated prior to receipt of the patient healthcare data, and upon or subsequent to receipt of the patient healthcare data, the healthcare treatment model may be identified based on a correspondence between the set of clinical treatment guidelines from which the healthcare treatment model was generated and one or more medical conditions identified by the patient healthcare data.

At block 408, computer-executable instructions provided as part of the healthcare treatment selection support module(s) may be executed to identify and designate a first decision node of the clinical decision tree(s) of the healthcare treatment model generated at block 404 as a current decision node.

Blocks 410-418 represent processing that may be performed iteratively to traverse one or more clinical decision trees of the healthcare treatment model generated at block 404. At block 410, a determination may be made as to whether traversal of the clinical decision tree(s) of the healthcare treatment model is complete. Responsive to a positive determination at block 410, the method 400 may proceed to block 420 where at least one recommended healthcare treatment may be identified. Information identifying the at least one recommended healthcare treatment may then be communicated to a healthcare provider system for presentation to a healthcare provider to assist in treatment selection.

On the other hand, if it is determined at block 410 that additional decision node determinations are left to be made as part of the traversal of the clinical decision tree(s) of the treatment model in order to identify a recommended healthcare treatment, the method 400 may proceed to block 412 where a determination may be made as to whether available patient healthcare data is sufficient to make a determination associated with the current decision node. At an initial iteration of the iterative processing of blocks 410-418, the available patient healthcare data may include only that patient data initially received at block 406. In subsequent iterations, the available patient healthcare data may include derived or inferred patient healthcare data and/or additional patient healthcare data requested from the healthcare provider system.

Responsive to a positive determination at block 412, the method 400 may proceed to block 418 where the determination associated with the current decision node may be made based on the available patient healthcare data and the clinical decision tree(s) may be traversed to the next decision node based on the determination result. The next decision node may then be designated as the current decision node. From block 418, the method 400 may again proceed to block 410.

On the other hand, if it is determined at block 412 that the available patient healthcare data is insufficient to make the determination associated with the current decision node, the method 400 may proceed to block 414 where a determination may be made as to whether the determination associated with the current decision node may be made based on derived or inferred patient healthcare data. Responsive to a positive determination at block 414, the method may proceed to block 418 where the determination associated with the current decision node may be made based on the available patient healthcare data (including derived or inferred patient healthcare data) and the clinical decision tree(s) may be traversed to the next decision node based on the determination result. The next decision node may then be designated as the current decision node. While not explicitly depicted in FIG. 4, it should be appreciated that prior to the operation of block 418 and subsequent to a positive determination at block 414, additional patient healthcare data may be derived or inferred from existing patient healthcare data based on one or more clinical rules.

On the other hand, if it is determined at block 414, that additional patient healthcare data cannot be derived or inferred from existing patient healthcare data or that even if such derivation or inference is possible, the available patient healthcare data would still be insufficient to make the determination associated with the current decision node, the method 400 may proceed to block 416 where additional patient healthcare data may be requested and received. More specifically, the healthcare treatment determination system 102 may generate and communicate a request for the additional patient healthcare data to the healthcare provider system 110 and receive the requested information therefrom. Upon receipt of the requested additional patient healthcare data, the method 400 may again proceed to block 412. The processing of blocks 410-418 may be performed iteratively until all decision node determinations that may be necessary to identify at least one recommended healthcare treatment are made.

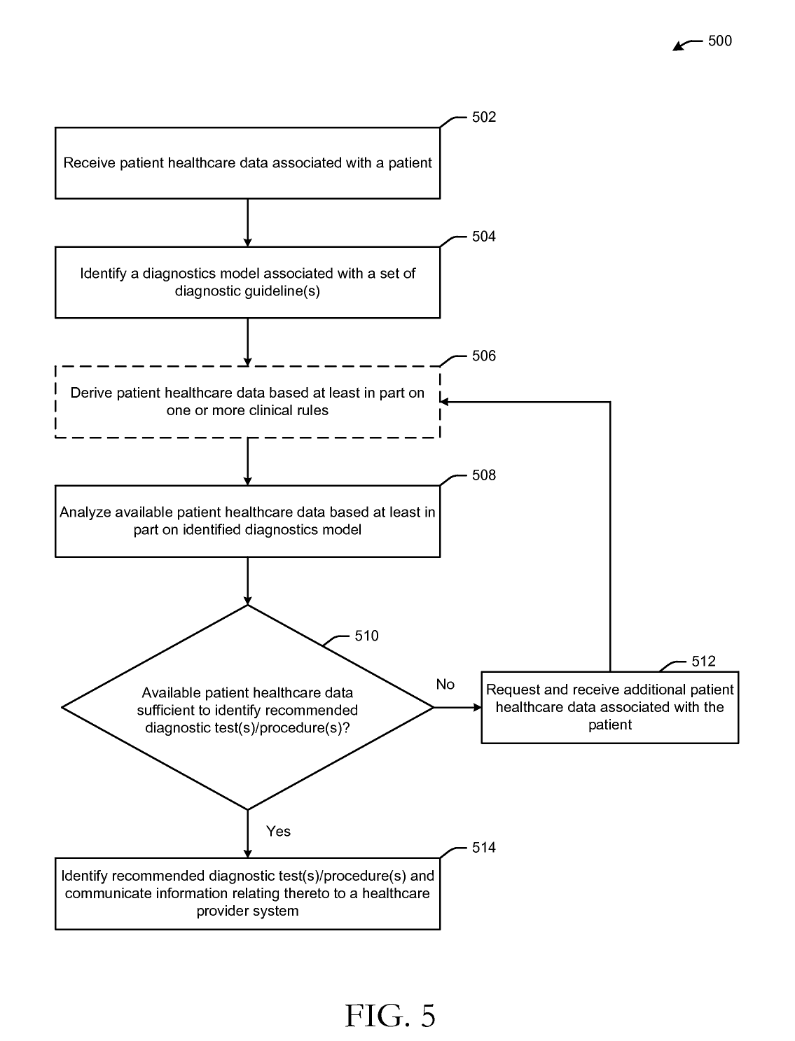

FIG. 5 is a process flow diagram of an illustrative method 500 for determining recommended diagnostic test(s)/procedure(s) based on an analysis of patient healthcare data with respect to a diagnostics model associated with relevant diagnostic guidelines and communicating information identifying the recommended diagnostic test(s)/procedure(s) to a healthcare provider in accordance with one or more embodiments of the disclosure. One or more operations of the illustrative method 500 may be performed responsive to execution of computer-executable instructions of one or more program modules executing on one or more healthcare treatment determination computers 202 of the healthcare treatment determination system 102, which in certain embodiments may support such functionality.

At block 502, patient healthcare data may be received by the healthcare treatment determination system 102 from, for example, a healthcare provider system 110. The received patient healthcare data may include any healthcare data associated with a patient including, but not limited to, patient medical history information including information relating to patient symptoms documented during clinical visits, information relating to past and/or current healthcare treatments administered to the patient, results of diagnostic test(s)/procedure(s) administered to the patient, and so forth.

At block 504, a healthcare diagnostics model associated with a set of diagnostic guidelines may be identified. The healthcare diagnostics model identified at block 504 may have been previously generated based on the set of diagnostic guidelines. At optional block 506, additional patient healthcare data may be derived or inferred from presently available patient healthcare data based on one or more clinical rules. In certain embodiments, the presently available patient healthcare data may not be sufficient to derive or infer further patient healthcare data.

At block 508, available patient healthcare data (which may include received patient healthcare data and/or derived or inferred patient healthcare data) may be analyzed based on the identified healthcare diagnostics model. In certain embodiments, blocks 506-512 of the method 500 may represent iterative processing that may be performed until available patient healthcare data is sufficient to identify at least one recommended diagnostic test or procedure.

At block 510, a determination may be made as to whether the presently available patient healthcare data is sufficient to make all determinations associated with the healthcare diagnostics model that may be necessary to identify at least one recommended diagnostic test or procedure. Responsive to a negative determination at block 510, the method 500 may proceed to block 512 where additional patient healthcare data associated with the patient may be requested by the healthcare treatment determination system 102 and received from the healthcare provider system 110. Upon receipt of the additional patient healthcare data, the method 500 may again proceed to optional block 506.

The iterative processing of blocks 506-512 may be performed until a determination may be made at block 510 that presently available patient healthcare data is sufficient to identify at least one recommended diagnostic test or procedure. Responsive to a positive determination at block 510, one or more recommended diagnostic tests or procedures may be identified at block 514 and information identifying such test(s) or procedure(s) may be communicated to the healthcare provider system for presentation to a healthcare provider.

In accordance with the illustrative methods 300, 400 and 500, healthcare treatments and/or diagnostic test(s)/procedure(s) that comply with relevant treatment or diagnostic guidelines may be determined in an automated manner on behalf of healthcare providers and presented to healthcare providers in order to increase the frequency with which clinical guidelines are followed by healthcare providers in selecting healthcare treatments and/or diagnosing medical conditions. While not explicitly depicted as part of the illustrative methods described above, in certain embodiments, upon communicating information identifying at least one recommended healthcare treatment and/or one or more diagnostic tests or procedures, additional patient healthcare data may be received by the healthcare treatment determination system 102 from the healthcare provider system 110. The additional patient healthcare data may include data associated with the patient (e.g., test results, health status metrics, etc.) subsequent to administering of the recommended healthcare treatment(s) and/or the recommended diagnostic test(s) or procedure(s). Further healthcare treatment(s) and/or diagnostic test(s) or procedure(s) may then be identified based on the additional patient healthcare data that is received. In addition, as previously described, feedback data may be solicited and received from the healthcare provider in those instances in which the healthcare provider chooses to select an alternate treatment or administer an alternate diagnostic test or procedure that differs from a recommended treatment or a recommended diagnostic test or procedure. The feedback data that is solicited may include a rationale for choosing the alternate treatment or alternate diagnostic test or procedure, supporting evidence for the alternate treatment or alternate diagnostic test or procedure, and so forth. The feedback data may be communicated, for example, to an entity tasked with establishing clinical treatment or diagnostic guidelines and may be assessed to determine whether the feedback data supports modifying the existing guidelines, removing certain guideline(s), or including additional guideline(s).

The operations described and depicted in the illustrative methods 300, 400, and 500 of FIGS. 3-5 may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIGS. 3-5 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment. Further, any data, component, element, determination, condition, or the like, described as forming a basis for another determination, condition, processing, or the like, may form a partial basis.

What is claimed is:

1. A method, comprising:
receiving, by a healthcare treatment determination system comprising one or more computers, healthcare data associated with a patient;
identifying, by the healthcare treatment determination system, a healthcare treatment model associated with a set of one or more treatment guidelines;
determining, by the healthcare treatment determination system, at least one recommended healthcare treatment for the patient based at least in part on the healthcare data and the healthcare treatment model; and
communicating, by the healthcare treatment determination system to a healthcare provider system, information identifying the at least one recommended healthcare treatment for the patient.

2. The method of claim 1, wherein the healthcare data comprises information identifying one or more diagnosed medical conditions associated with the patient, and wherein identifying the healthcare treatment model comprises:
identifying, by the healthcare treatment determination system, the set of one or more treatment guidelines based at least in part on the information identifying the one or more diagnosed medical conditions associated with the patient; and
generating, by the healthcare treatment determination system, the healthcare treatment model based at least in part on the set of one or more treatment guidelines.

3. The method of claim 2, wherein generating the healthcare treatment model comprises:
generating, by the healthcare treatment determination system, a treatment decision tree comprising a plurality of decision nodes, wherein each of the plurality of decision nodes corresponds to a respective determination as to whether a respective at least a portion of the healthcare data satisfies a respective set of one or more treatment selection criteria.

4. The method of claim 1, further comprising:
determining, by the healthcare treatment determination system, that additional healthcare data associated with the healthcare patient is required in order to determine the at least one recommended healthcare treatment;
communicating, by the healthcare treatment determination system to the healthcare provider system, a request for the additional healthcare data; and
receiving, by the healthcare treatment determination system from the healthcare provider system, the additional healthcare data,
wherein the at least one recommended healthcare treatment is determined further based at least in part on the additional healthcare data.

5. The method of claim 1, further comprising:
identifying, by the healthcare treatment determination system, one or more clinical rules;
determining, by the healthcare treatment determination system, that the healthcare data satisfies the one or more clinical rules; and
determining, by the healthcare treatment determination system, additional healthcare data associated with the patient based at least in part on determining that the healthcare data satisfies the one or more clinical rules.

6. The method of claim 5, wherein the at least one recommended healthcare treatment is determined further based at least in part on the additional healthcare data.

7. The method of claim 1, wherein the healthcare data comprises information identifying one or more diagnosed medical conditions associated with the patient and at least one of:
i) one or more metrics indicative of a health status of the patient, or
ii) information identifying one or more symptoms associated with the patient.

8. The method of claim 1, wherein the at least one recommended healthcare treatment comprises a plurality of candidate healthcare treatments.

9. The method of claim 1, wherein the healthcare data comprises first healthcare data, further comprising:
receiving, by the healthcare treatment determination system, second healthcare data associated with the patient subsequent to rendering of the at least one recommended healthcare treatment to the patient;
determining, by the healthcare treatment determination system, at least one additional recommended healthcare treatment for the patient based at least in part on the second healthcare data and the healthcare treatment model; and
communicating, by the healthcare treatment determination system to the healthcare provider system, information identifying the at least one additional recommended healthcare treatment for the patient.

10. A system, comprising:
at least one processor; and
at least one memory storing computer-executable instructions,
wherein the at least one processor is configured to access the at least one memory and execute the computer-executable instructions to:
receive healthcare data associated with a patient;
identify a healthcare treatment model associated with a set of one or more treatment guidelines;
determine at least one recommended healthcare treatment for the patient based at least in part on the healthcare data and the healthcare treatment model; and
communicate, to a healthcare provider system, information identifying the at least one recommended healthcare treatment for the patient.

11. The system of claim 10, wherein the healthcare data comprises information identifying one or more medical conditions associated with the patient, and wherein, to identify the healthcare treatment model, the at least one processor is configured to execute the computer-executable instructions to:
identify the set of one or more treatment guidelines based at least in part on the information identifying one or more medical conditions associated with the patient; and
generate the healthcare treatment model based at least in part on the set of one or more treatment guidelines.

12. The system of claim 11, wherein, to generate the healthcare treatment model, the at least one processor is configured to execute the computer-executable instructions to:
generate a treatment decision tree comprising a plurality of decision nodes, wherein each of the plurality of decision nodes corresponds to a respective determination as to whether a respective at least a portion of the healthcare data satisfies a respective set of one or more treatment selection criteria.

13. The system of claim 10, wherein the at least one processor is further configured to execute the computer-executable instructions to:
determine that additional healthcare data associated with the healthcare patient is required in order to determine the at least one recommended healthcare treatment;
communicate, to the healthcare provider system, a request for the additional healthcare data; and
receive, from the healthcare provider system, the additional healthcare data,
wherein the at least one processor is configured to execute the computer-executable instructions to determine the at least one recommended healthcare treatment further based at least in part on the additional healthcare data.

14. The system of claim 10, wherein the at least one processor is further configured to execute the computer-executable instructions to:
identify one or more clinical rules;
determine that the healthcare data satisfies the one or more clinical rules; and
determine additional healthcare data associated with the patient based at least in part on a determination that the healthcare data satisfies the one or more clinical rules.

15. The system of claim 14, wherein the at least one processor is configured to execute the computer-executable instructions to determine the at least one recommended healthcare treatment further based at least in part on the additional healthcare data.

16. The system of claim 10, wherein the healthcare data comprises information identifying one or more diagnosed medical conditions associated with the patient and at least one of:
i) one or more metrics indicative of a health status of the patient, or
ii) information identifying one or more symptoms associated with the patient.

17. The system of claim 10, wherein the at least one recommended healthcare treatment comprises a plurality of candidate healthcare treatments.

18. The system of claim 10, wherein the healthcare data comprises first healthcare data, and wherein the at least one processor is further configured to execute the computer-executable instructions to:
receive second healthcare data associated with the patient subsequent to rendering of the at least one recommended healthcare treatment to the patient;
determine at least one additional recommended healthcare treatment for the patient based at least in part on the second healthcare data and the healthcare treatment model; and
communicate, to the healthcare provider system, information identifying the at least one additional recommended healthcare treatment for the patient.

19. One or more computer-readable media storing computer-executable instructions that responsive to execution cause operations to be performed comprising:
receiving, by a healthcare diagnostics determination system comprising one or more computers, healthcare data associated with a patient;
identifying, by the healthcare diagnostics determination system, a healthcare diagnostics model associated with a set of one or more diagnostic guidelines;
determining, by the healthcare diagnostics determination system, at least one recommended diagnostic test or procedure to be administered to the patient based at least in part on the healthcare data and the healthcare diagnostics model; and
communicating, by the healthcare diagnostics determination system to a healthcare provider system, information identifying the at least one recommended diagnostic test or procedure to be administered to the patient.

20. The one or more computer-readable media of claim 19, wherein the healthcare data comprises at least one of:
i) one or more metrics indicative of a health status of the patient, or
ii) information identifying one or more symptoms associated with the patient.
